(19) United States
(12) Patent Application Publication
(10) Pub. No.: US 2006/0015549 A1
(43) Pub. Date: Jan. 19, 2006

(54) Method and apparatus for generation of gaussian deviates

(76) Inventor: William A. Chren, Longmont, CO (US)

Correspondence Address: Lisa K. Jorgenson;ST Microelectronics, Inc., Mail Stop 2346, 1310 Electronics Drive, Carrollton, TX, 75006, US

(21) Appl. No.: 10/889,676

(22) Filed: Jul. 13, 2004

(51) Int. Cl. G06F 7/38

(52) U.S. Cl. 708/446

(57) ABSTRACT

Samples from a gaussian distribution are used for simulating the performance of communication channels that are corrupted with additive white gaussian noise (AWGN). There is a need for fast, efficient methods of computing these samples, particularly in hardware. Speed of generation is important because, in many cases, the samples must be produced in real-time at the channel data rate. Efficiency of generation is especially important for FPGA-based implementations or other types of design or test systems where on-chip memory is in short supply.

### BACKGROUND OF THE INVENTION

This application relates to a method and apparatus for generating gaussian deviates and their application to communication channels.

### THE TRADITIONAL METHOD

The traditional method for generating gaussian deviates is the Inverse Distribution Method. One realization of this method 10 is shown in FIG. 1, which includes a ROM 3 having a lookup table that stores the deviates. The ROM 3 is addressed by uniformly-distributed addresses, generated by a linear feedback shift register (LFSR 1). The output frequency of occurrence of a particular deviate y is set by the number of copies of y that is stored in the ROM 3.

More precisely, the LFSR 1 generates a maximal length sequence {xᵢ} of uniform deviates in the interval [0, 2ⁿ−1], where n is the number of ROM 3 address bits. The ROM 3 contains all possible values that can occur in the output sequence {yᵢ } of normal deviates. Let #(y) equal the number of ROM 3 locations that contain the value y. Then #(y) is a member of the set of values in the interval [1, 2ⁿ], that is, #(y)∈[1,2ⁿ]. In other words, the number of copies stored of any output value can be any positive integer up to the size of the ROM 3. Furthermore, for long output sequences {yᵢ }, the frequency of occurrence of y in the sequence is given by #(y)/2ⁿ, because the addresses are equally likely. In order to generate deviates from the normal distribution N(m, σ), we must choose #(y) for each y such that #(y)/2′ obeys the distribution N(m, σ). The determination of #(y) according to a desired gaussian distribution will now be discussed.

The first step is to bin the distribution. The centers of the bins will be the possible deviate values, i.e., the values that must be stored in the ROM. The number k of bins determines the number of storage locations required in the ROM. Let the center of bin i be denoted yᵢ, i∈[1,k]. Then the size S of the ROM is given by

$$S = {\sum }_{1}^{k} \# ( {y}_{i} ) .$$

As an example, consider FIG. 2, which shows a binned version of the desired (continuous) density function N(0, 1), binned into 17 bins with centers {yᵢ}. The value of the density function in bin i is denoted by fᵢ, and is equal to the area under the continuous curve over the interval centered on yᵢ and having width equal to the bin width. In the circuit output sequence we want the frequency of occurrence of yᵢ to equal fᵢ. That is,
Prob(yᵢ)=#(yᵢ)/2ⁿ=fᵢ,
where Prob(*) denotes probability. Accordingly, for a given size ROM, the value #(yᵢ) is given by 2ⁿfᵢ. These values are given in Table 1 of FIG. 3. For this example, the ROM 3 has a depth of 65 locations, found as the sum of the entries in column two of the table. Utilizing the disclosed embodiments, the depth of the ROM 3 can be reduced to 11 locations, a reduction of 83%.

### SUMMARY OF THE INVENTION

Samples from a gaussian distribution are used for simulating the performance of communication channels that are corrupted with additive white gaussian noise (AWGN). There is a need for fast, efficient methods of computing these samples, particularly in hardware. Speed of generation is important because, in many cases, the samples must be produced in real-time at the channel data rate. Efficiency of generation is especially important for FPGA-based implementations or other types of design or test systems where on-chip memory is in short supply.

The generation of gaussian deviates while consuming very little on-chip storage when compared with existing methods of generation is disclosed. The large lookup table used in one method is replaced with a maximal length linear feedback shift register (LFSR), multiplexer (MUX), and an adder tree of small depth. The adder tree computes the number of ones (i.e., the Hamming weight, the number of non-zero symbols in a symbol sequence, or for binary signaling, Hamming weight is the number of 1-bits in the binary sequence) in the LFSR after each clock edge. These values of Hamming weight have a binomial distribution and, as discussed above, approximate a gaussian distribution. They are used as the select inputs for the MUX. The data inputs of the MUX are the values of the desired output deviates. The storage reduction that is enabled by the use of this technique will be advantageous in those integrated circuit applications which have limited on-device storage resources. The disclosed apparatuses and method eliminates the lookup table that stores #(yᵢ) copies of each output word. Instead, it stores a single copy of each output word, and uses a statistical multiplexer to selectively pass these words to the output in such a way that the probability of occurrence of a particular word in the output stream obeys the target gaussian distribution. These words are the linearly-transformed versions of the outputs x of a circuit which computes values of combin(n,k) for fixed n. The coefficients a, b of the transformation are as given previously.

### MATHEMATICAL PREREQUISITES

The Demoivre-Laplace Theorem states that the binomial distribution C(n,k)p^{k}q^{n-k} approximates the gaussian distribution N(np,(npq)^{0.5}) as a function of k for large n. For p=q=0.5, we conclude that the gaussian distribution N(0.5n, 0.5n^{0.5}) is approximated by combin(n,k)≡2⁻ⁿn!/k!(n−k)!.

FIG. 4 shows both these functions for n=64, for which the normal density function has mean 32 and variance 16. The figure shows excellent approximation. FIG. 5 substantiates the quality of the approximation. It is a plot of the mean-square error between these functions as a function of n.

As discussed above, deviates x can be generated from the distribution N(0.5n, 0.5n^{0.5}) by computing the expression combin(n,k) as a function of k with fixed n. In most practical cases, however, distributions other than N(0.5n, 0.5n^{0.5}) are desired. The generation of deviates from gaussian distributions N(m, σ) having arbitrary means and variances will be discussed below.

It can be shown that a linear transformation ax+b of a random variable x having distribution N(r,s) yields another random variable y having distribution N(ar+b, as). In the disclosed embodiments, x will be values of combin(n,k), with r=0.5n and s=0.5n^{0.5}. This distribution can be transformed to the target distribution N(m, σ) by using a=2σn^{-1/2} and b=m−σn^{1/2}. Because the target mean and standard deviation are constants, the transformation is done without using any extra circuitry, as will now be discussed.

### BRIEF DESCRIPTION OF THE FIGURES

FIG. 1 is a block diagram of the of the prior art system for obtaining gaussian deviates;

FIG. 2 is a diagram of a normal distribution binned with 17 bins;

FIG. 3 is a table illustrating the bin centers of FIG. 2 with the number of memory locations required for each of the centers;

FIG. 4 is a plot comparing binomial distribution with normal distribution;

FIG. 5 is a plot illustrating the mean sequence error between the normal density function and combination approximation vs. n;

FIG. 6 is a block diagram of a system that practices the preferred embodiment;

FIG. 7 is a block diagram of the signal generator of FIG. 6;

FIG. 8 is a block diagram of a first embodiment of a method and apparatus for generating gaussian deviates;

FIG. 9 is a block diagram of a second embodiment of a method and apparatus for generating gaussian deviates;

FIG. 10 is a block diagram of the combin(n,k) circuit of the first and second embodiments;

FIG. 11 is a block diagram of the alternate embodiment of the combin(n,k) circuit;

FIG. 12 is a schematic diagram of the justify circuit of FIG. 11;

FIG. 13 is a schematic diagram of a LFSR circuit; and

FIG. 14 is a comparison of outputs using the disclosed method and the ideal distribution.

### DETAILED DESCRIPTION OF THE EMBODIMENTS

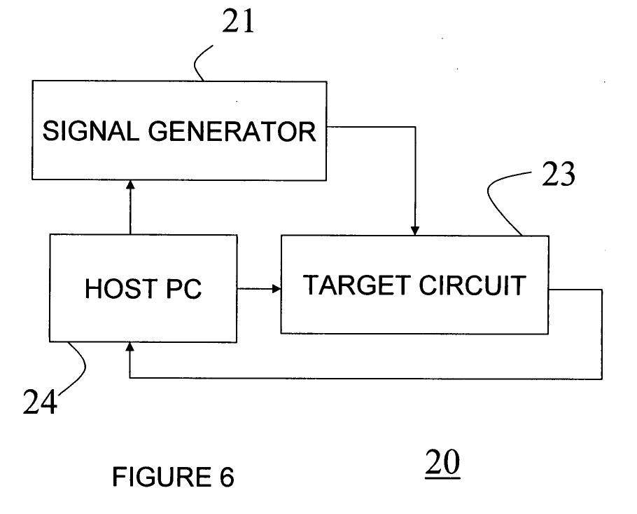

A block diagram of a system practicing one embodiment is illustrated in FIG. 6. The system includes a target circuit 23 that is being used to test, designed or calibrated a circuit such as a communication channel. In the design case the target circuit can be a device such as a FPGA (field programmable gate array). A signal generator 21 provides test signals that are applied to the target circuit 23. The target circuit 23 is control by a host PC 24 as is the signal generator.

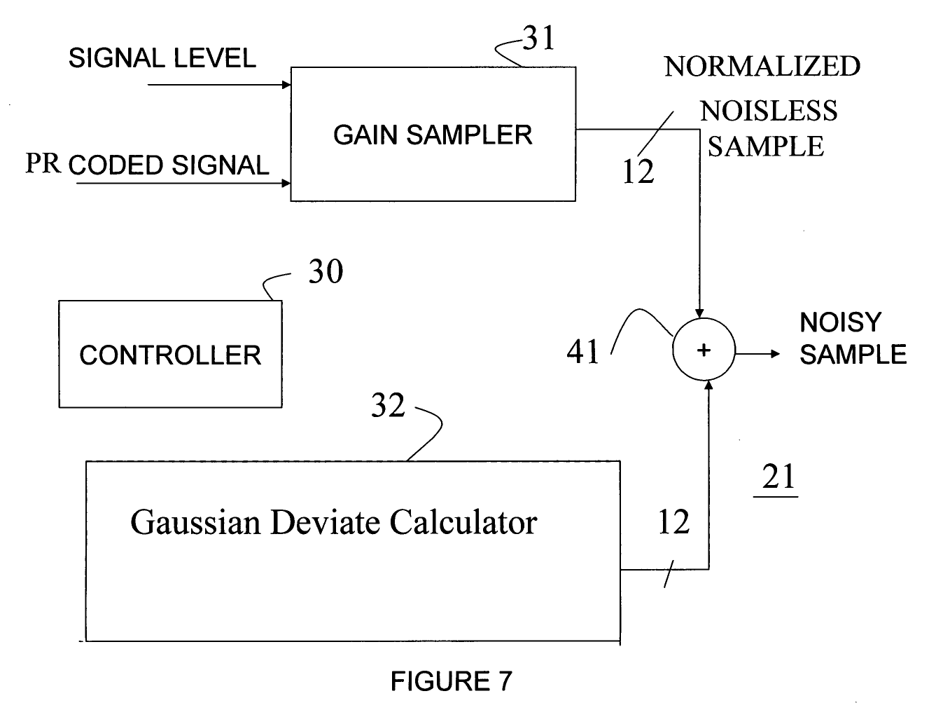

A block diagram of the signal generator 21 is illustrated in FIG. 7 to which reference shall now be made. A gain sampler 32 provides a normalized noiseless signal sample under the control of a signal level input and the controller 30. A coded signal that is coded by one of the partial response codes is applied to the gain sampler for normalization. Gaussian deviates are provided by the gaussian deviate calculator 32 and summed by adder 41 with the normalized noiseless sample to provide a noisy sample for application to the target circuit 23.

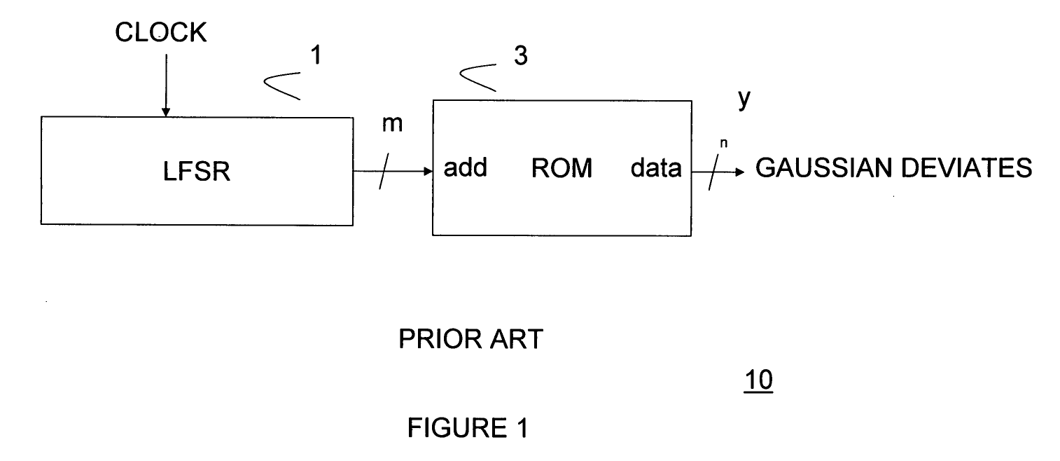

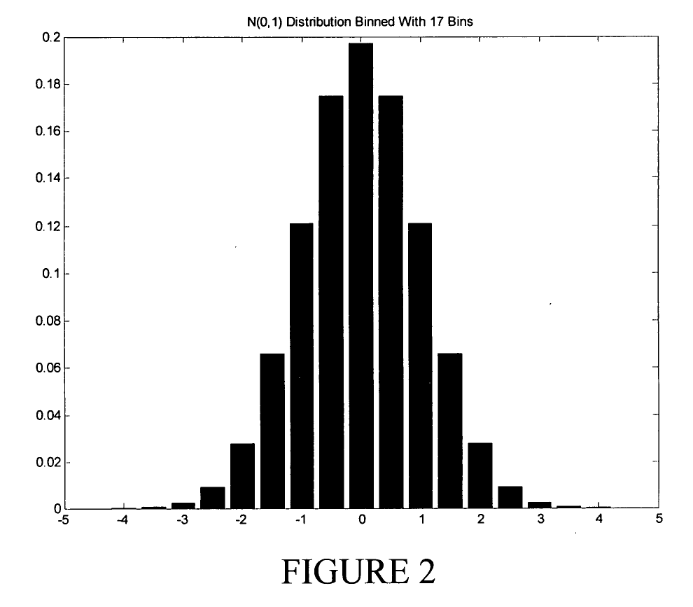

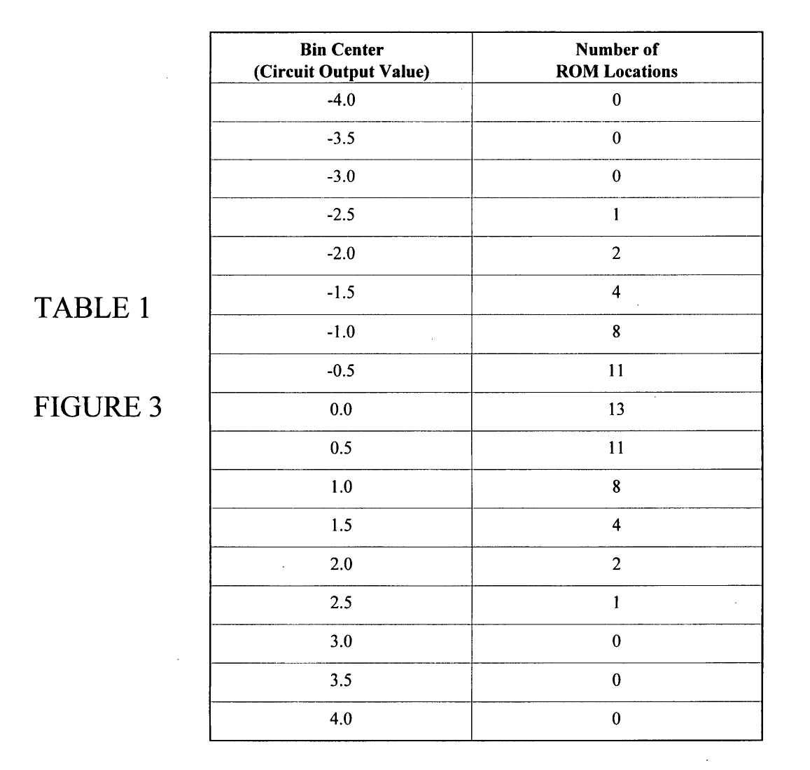

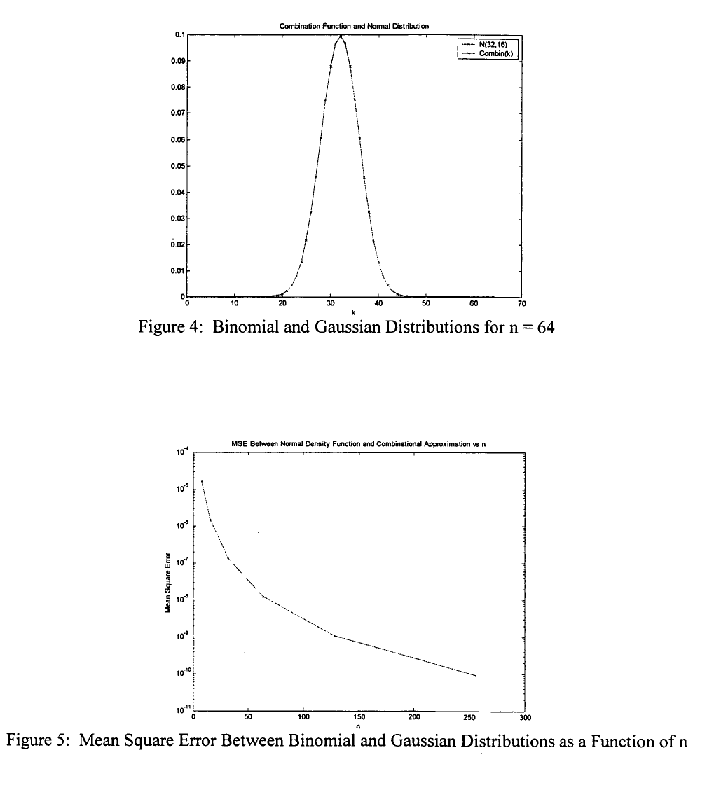

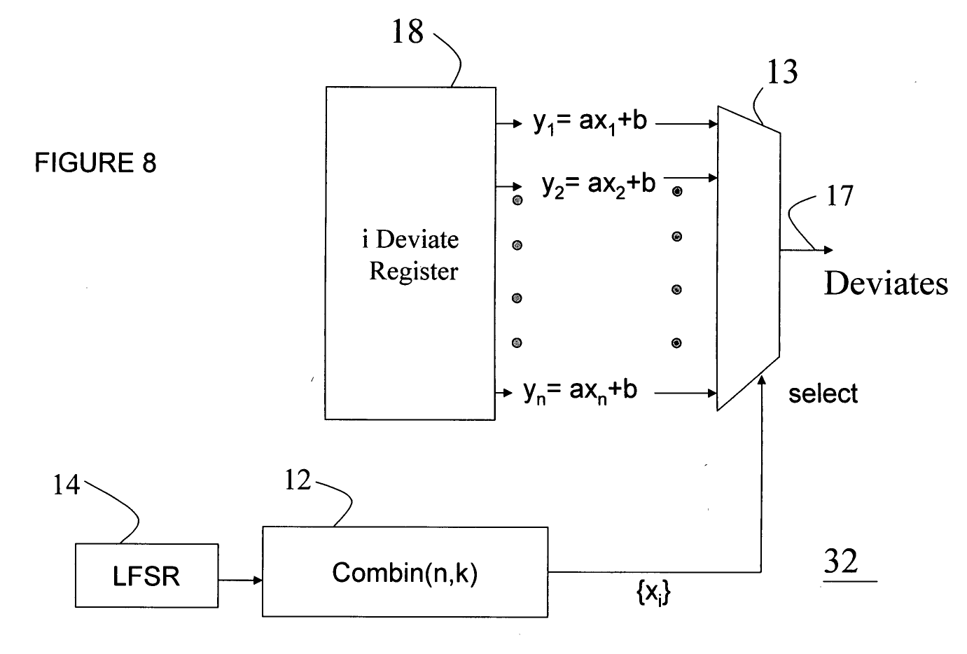

FIG. 8 is a schematic diagram of the gaussian deviate calculator 32. Note that the lookup table of FIG. 1 has been replaced by an LFSR 14, a combin(n,k) circuit 12, i deviate register 18, and a multiplexer (MUX) 13. In applications where memory is not available or in short supply, this replacement is quite advantageous. The output of the combin(n,k) circuit 12 drives the select inputs of a regular multiplexer (MUX) 13 whose data inputs yᵢ are the transformed outputs of the combin(n,k) circuit 12. The LFSR 14 is maximal-length and randomly generates all 2ⁿ−1 non zero n-bit binary words. The combin(n,k) circuit 12 computes the number of 1-bits in each of these words. These values can be formatted in one of several ways, such as binary or one-hot, depending on efficiency of implementation. The values of yᵢ are stored in a memory such as the i deviate register 18 that is substantially smaller in size than that used for the embodiment of FIG. 1, as each value of yᵢ is only stored in a single location within the i word register 18.

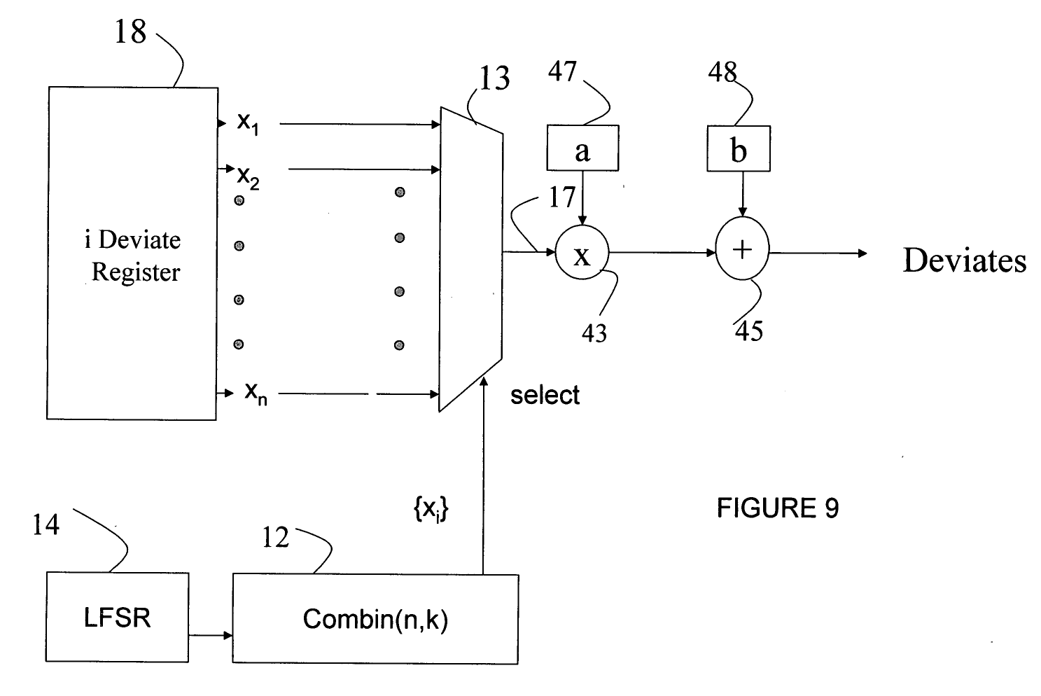

In an alternate but similar embodiment shown in FIG. 9 only the values of xᵢ are stored in the memory register 18. Because a and b are constants the values of yᵢ may be calculated at the output of the MUX. The output of the MUX 13 is applied to a multiplier 43 which multiplies the output of the MUX 13 with the constant a. The output of the multiplier 43 is applied to an adder 45 which adds the constant b to the product axᵢ to obtain the desired value of yᵢ.

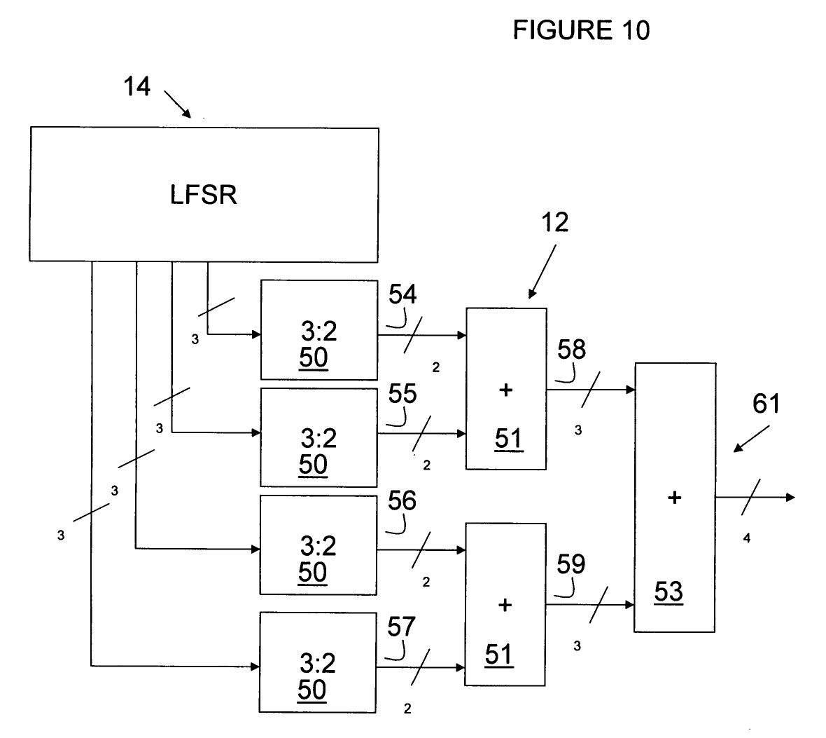

FIG. 10 is a detailed block diagram of the gaussian deviate generating circuit 32 which provides additional detail for the combin(n,k) circuit 12. The value n=12 is used in this figure. The combin(n,k) circuit 12 combines, in the embodiment of FIG. 10, the 12 output bits of the LFSR 14. The combin(n,k) circuit 32 includes four 3:2 combiners 50 which, in practice, can be implemented as done in carry save adders (CSA). The output of the combiners 54 and 55 are combined by adder 58 and the output of combiners 56 and 57 are combined by adder 59. The output of adders 58 and 59 are combined by adder 61 to achieve a four bit output for application to the select input of the MUX 13.

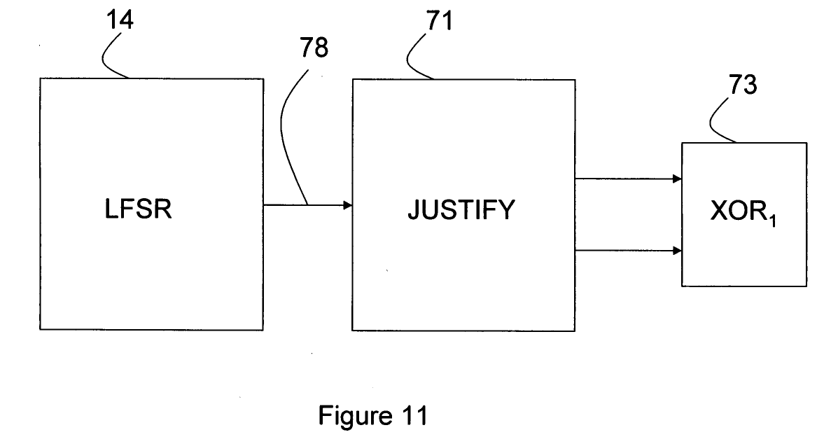

An alternative implementation employing the thermometer code representation is given in FIG. 11. The idea is to justify the LFSR bits with a justifier 71 which receives the parallel outputs from the LFSR 14 via connection 78. The location of the 1-to-O transition in the justified result indicates the number of ones in the LFSR 14 and can be used to drive the MUX 13. This location, which will be one-hot encoded, is found by a bank of 2-input Exclusive OR, gates 73 which operate on adjacent justifier 71 output bits. The justifier 71 can be thought of as a “generalized” shift register in which only logic 1-bits are shifted. It can be implemented in several ways, including asynchronous methods, whose advantage is lower latency and power consumption. Because the select inputs of the MUX 13 are one-hot encoded, the MUX 13 latency is reduced.

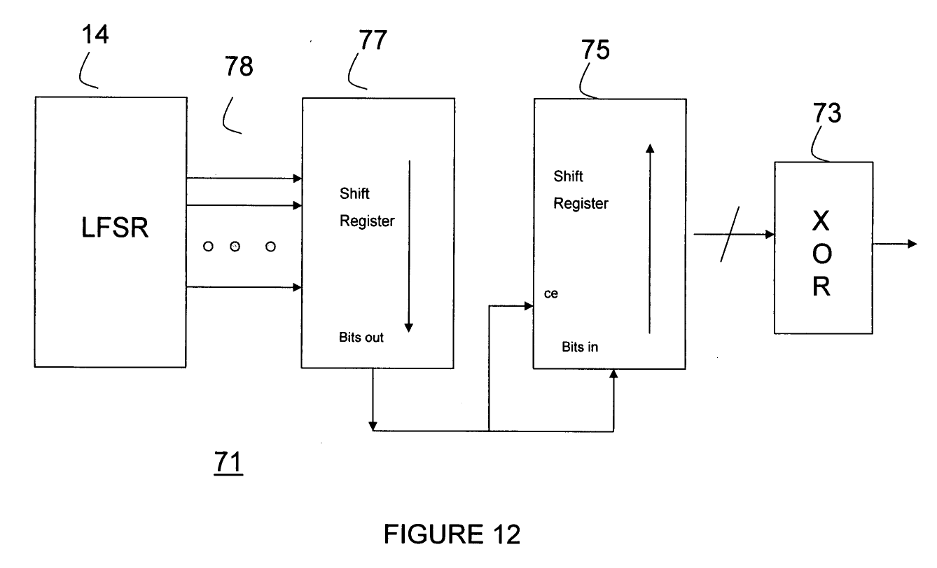

FIG. 12 is a diagram of the justifier 71 and includes a parallel shift register 77 that receives the parallel outputs from the LFSR 14 and shifts the data to the shift register 75. Only the 1-bits in shift register 77 are shifted in shift register 75. That is, as shift register 77 is shifted down in the figure, only the 1-bits are shifted into shift register 75. After shift register 77 is completely shifted, shift register 75 contains the justified 1-bits from shift register 77. The outputs of the shift register 75 are exclusively ORed together by the Exclusive OR, gates 73 and applied to the MUX 13.

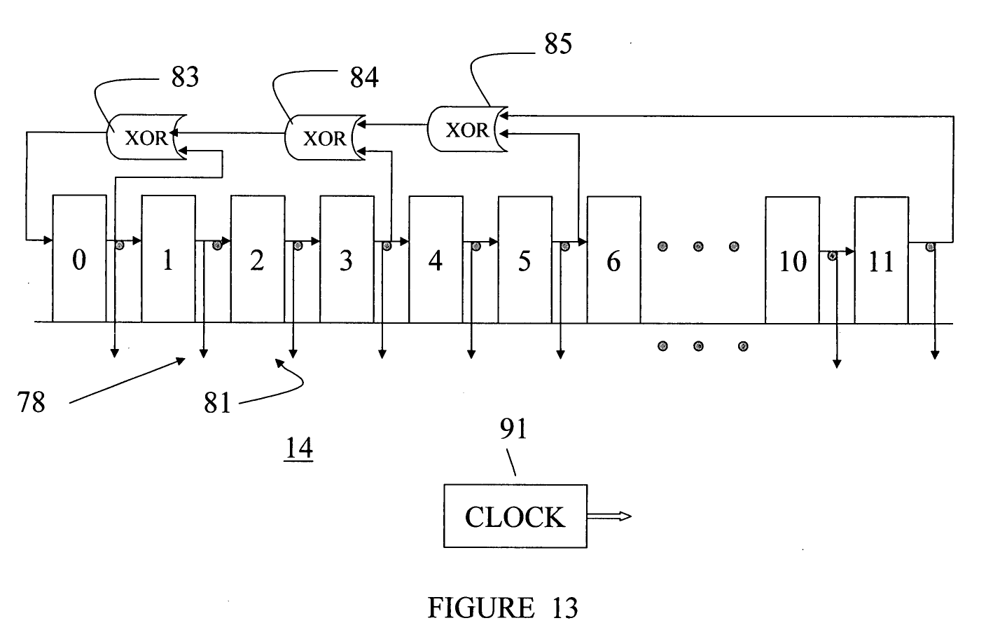

FIG. 13 is a schematic diagram of the LFSR 14 as implemented in the disclosed embodiments. It includes a 12-bit shift register 81 having four taps, bits 0, 3, 5, and 11. Although there are many tap locations that will work equally as well the disclosed embodiment provides a maximum length sequence which means that pseudo random numbers will not repeat as often as with a non maximum length sequence. The output from bit 11 is exclusively ORed with the output from bit 5 by exclusive OR (XOR) gate 85. The output from ExclusiveOR (XOR) gate 85 is exclusively ORed with the output from bit 3 by ExclusiveOR (XOR) gate 84. The output from exclusive OR (XOR) gate 84 is exclusively ORed with the output from bit 0 by exclusive OR (XOR) gate 83. The output from the exclusive OR (XOR) gate 83 is applied to the input of the first register of the shift register 81. A clock 91 provides a clock pulse to each stage 0 through 111 at the occurrence of which provides a new binary sequence on the output terminals 78.

Simulation Results

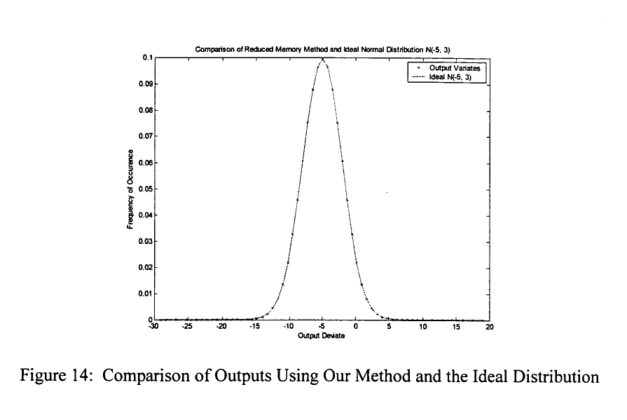

We have simulated the disclose method with a MATLAB model. FIG. 14 shows the results for n=64 and a target distribution of N(−5, 3). Clearly, there is excellent agreement between the generated deviates and the ideal distribution.

Although the embodiments disclosed are based on positive logic, the embodiments may also be implemented using logic zeros as is known in the art. Additionally, many of the functions may be implemented with software.

I claim:

1. A gaussian deviate generation circuit comprising:
a memory having a first plurality of gaussian deviates stored in n locations where n is a positive integer;
a maximal-length sequence generator for generating a plurality of binary sequences;
a Hamming weight combiner for obtaining the Hamming weight of each member of the plurality of binary sequences generated by the maximal-length sequence generator, the Hamming weight combiner being operatively connected to the maximal-length sequence generator; and
a statistical multiplexer circuit having a plurality of n inputs with each input being connected to receive a single member of the plurality of gaussian deviates, the multiplexer also having select inputs, the select inputs being connected to receive the Hamming weight obtained by the Hamming weight combiner.

2. The gaussian deviate generation circuit according to claim 1 wherein the maximal-length sequence generator comprises:
a linear feedback shift register circuit having a plurality of n outputs.

3. The gaussian deviate generation circuit according to claim 2 wherein the Hamming weight combiner comprises:
a combining circuit having a plurality of n inputs operatively connected to the plurality of n outputs, the combining circuit providing a plurality of m outputs, where m is less than n.

4. The gaussian deviate generation circuit according to claim 3 wherein the select inputs of the statistical multiplexer circuit comprises:
a plurality of m inputs.

5. The gaussian deviate generation circuit according to claim 1 further comprising:
a gain sampler for providing a normalized noiseless sample from a coded signal and a predetermined signal level; and
an adder for adding the normalized noiseless sample to the output of the multiplexer to obtain a noisy sample.

6. The gaussian deviate generation circuit according to claim 5 further comprising:
a target circuit operatively connected to receive the noisy sample.

7. The gaussian deviate generation circuit according to claim 1 wherein the first plurality of gaussian deviates stored in the memory comprises:
axᵢ+b, where xᵢ is a variable with i having a range of from 1 to n, x also having a distribution of N(r,s) with r being equal to a mean of 0.5n and s being equal to a variance of 0.5n^{0.5}; with a being equal to 2σn^{-1/2} where σ is the target variance and b being equal to m−σn^{1/2} where m is the target mean.

8. A gaussian deviate generation circuit comprising:
a memory having a first plurality of xᵢ variables stored therein with i having a range from 1 to n, where n is a positive integer;
a maximal-length sequence generator for generating a plurality of binary sequences;
a Hamming weight combiner for obtaining the Hamming weight of each member of the plurality of binary sequences generated by the maximal-length sequence generator, the Hamming weight combiner being operatively connected to the maximal-length sequence generator; and
a statistical multiplexer circuit having a plurality of n inputs with each input being connected to receive a single member of the plurality of variables, the multiplexer also having select inputs, the select inputs being connected to receive the Hamming weight obtained by the Hamming weight combiner.

9. The gaussian deviate generation circuit according to claim 8 wherein the maximal-length sequence generator comprises:
a linear feedback shift register circuit having a plurality of n outputs.

10. The gaussian deviate generation circuit according to claim 9 wherein the Hamming weight combiner comprises:
a combining circuit having a plurality of n inputs operatively connected to the plurality of n outputs, the combining circuit providing a plurality of m outputs, where m is less than n.

11. The gaussian deviate generation circuit according to claim 10 wherein the select inputs of the statistical multiplexer circuit comprises:
a plurality of m inputs.

12. The gaussian deviate generation circuit according to claim 8 further comprising:
a multiplier circuit operatively connected to receive an output from the multiplexer and a first constant, the multiplier providing a first product as a result of the multiplication.

13. The gaussian deviate generation circuit according to claim 12 further comprising:
an adder circuit operatively connected to receive the product and a second constant and to provide as an output the sum of the product plus the second constant.

14. The gaussian deviate generation circuit according to claim 8 further comprising:
a gain sampler for providing a normalized noiseless sample from a coded signal and a predetermined signal level; and
an adder for adding the normalized noiseless sample with the output of the multiplexer to obtain a noisy sample.

15. A method of generating gaussian deviates comprising:
having a first plurality of gaussian deviates stored in a memory;
generating a plurality of binary sequences with a maximal-length sequence generator;
obtaining the Hamming weight of each member of the plurality of binary sequences generated by the maximal-length sequence generator; and
selecting a particular member of the plurality of gaussian deviates with a multiplexer in response to a particular Hamming weight.

16. The method according to claim 15 further comprising the step of generating a noisy signal from the particular member of the gaussian deviates.

17. The method according to claim 16 wherein the step of generating a noisy signal from the particular member of the gaussian deviates comprises;
providing a normalized noiseless signal sample from a coded signal and a predetermined signal level; and
combining the normalized noiseless signal sample with the selected member of the plurality of gaussian deviates to obtain a noisy sample.

18. The method according to claim 17 further comprises;
applying the noisy sample to a target circuit.

19. A method generating of gaussian deviates comprising:
having a first plurality of xᵢ variables stored in a memory with i having a range from 1 to n, where n is a positive integer;
generating a plurality of binary sequences with a maximal-length sequence generator;
obtaining the Hamming weight of each member of the plurality of binary sequences generated by the maximal-length sequence generator; and
selecting a particular member of the plurality of xᵢ variables with a multiplexer in response to a particular Hamming weight.

20. The method according to claim 19 further comprising:
multiplying an output from the multiplexer with a first constant, to provide a first product as a result of the multiplication.

21. The method according to claim 20 further comprising:
summing the product with a second constant to provide as an output the sum of the product plus the second constant.

22. The method according to claim 21 further comprising the step of generating a noisy signal from the sum.

23. The method according to claim 22 wherein the step of generating a noisy signal from the sum comprises;
providing a normalized noiseless signal sample from a coded signal and a predetermined signal level; and
combining the normalized noiseless signal sample with the sum to obtain a noisy sample.

24. The method according to claim 23 further comprises;
applying the noisy sample to a target circuit.
